(19) United States
(12) Patent Application Publication
(10) Pub. No.: US 2020/0154863 A1
(43) Pub. Date: May 21, 2020

(54) SLING ASSEMBLY AND METHOD THEREOF

(71) Applicant: Jacquelyn C. Chow, Austin, TX (US)

(72) Inventor: Jacquelyn C. Chow, Austin, TX (US)

(21) Appl. No.: 16/680,284

(22) Filed: Nov. 11, 2019

Related U.S. Application Data
(60) Provisional application No. 62/767,622, filed on Nov. 15, 2018.

(51) Int. Cl. A45F 3/14; B68B 9/00

(52) U.S. Cl. CPC A45F 3/14; A45F 2003/142; B68B 9/00

(57) ABSTRACT

A sling assembly to assist one to manually carry a saddle is provided. In one embodiment, the sling assembly includes an elongated shoulder strap portion and an elongated gullet supporting portion. The gullet supporting portion is positionable along and within an elongated gullet channel defined in an underside of the saddle. The elongated shoulder strap may be coupled at one end to an end portion of the gullet supporting portion so that the shoulder strap portion and the gullet supporting portion are coupled together in a continuous loop. With this arrangement, the sling assembly may support the saddle in a suspended position along one's side such that the shoulder strap portion is placed over one's shoulder with the gullet supporting portion positioned along an underside of the saddle within and along the gullet channel defined therein.

### CROSS-REFERENCE TO RELATED APPLICATIONS

This application claims the benefit of U.S. Provisional Application No. 62/767,622, filed Nov. 15, 2018, the disclosure of which is hereby incorporated by reference herein in its entirety.

### TECHNICAL FIELD

The present invention relates generally to equestrian assist accessories and, more specifically, the present invention relates to equestrian accessories to assist carrying saddles.

### BACKGROUND

One of the most expensive pieces of equipment that a horse riding enthusiast has is a saddle. The primary types of saddles include the western saddle, the dressage saddle, and the jump saddle. Each type of saddle includes a centrally located channel or gullet defined by raised panels and extending along the underside of the saddle. Upon positioning the saddle on the horse, this channel or gullet aligns with the spine of the horse for maximum comfort to the horse and protection to the spine. As such, for the saddle to be maintained in excellent condition, it is important that the panels and channel maintain their structural integrity and do not become deformed over time, the result which could potentially injure one's horse. Further, for many horse enthusiasts, depending on their size and strength, it can be difficult to carry the saddle due to most saddles weighing within the range between 10 and 30 pounds, which problem is compounded by the awkward shape of the saddle. This problem is especially recognized to those horse enthusiasts who regularly need to manually carry and transport the saddle relatively long distances between one's vehicle and the horse stable or to a suitable saddle storage location.

### BRIEF SUMMARY OF THE INVENTION

The present invention is directed to various embodiments of a sling assembly and method thereof. In one embodiment, a method for a person to manually carry a saddle is provided. The method includes the steps of: positioning an elongated gullet supporting portion of a sling assembly along and within an elongated gullet channel defined in an underside of the saddle; coupling one end of an elongated shoulder strap portion to a first end portion of the elongated gullet supporting portion so that the elongated shoulder strap portion and the elongated gullet supporting portion are coupled together in a continuous loop; and supporting the saddle with the sling assembly by positioning the elongated shoulder strap portion over a shoulder of the person with the elongated gullet supporting portion held and positioned along the gullet channel of the saddle.

In another embodiment, the positioning step includes positioning the gullet supporting portion along the gullet channel such that the gullet supporting portion is sized to limit longitudinal and lateral movement of the elongated gullet supporting portion relative to raised panels defining the gullet channel in the underside of the saddle. In another embodiment, the positioning step includes positioning a support pad of the gullet supporting portion along and within the gullet channel of the saddle such that the support pad at least partially surrounds a support strap of the gullet supporting portion. In still another embodiment, the positioning step includes positioning a support pad of the gullet supporting portion along and within the gullet channel of the saddle such that the support pad extends beyond ends of the gullet channel. In yet another embodiment, the positioning step includes positioning a support pad of the gullet supporting portion along and within the gullet channel such that the support pad defines a width, a length, and a depth, the width sized to be about a width of the elongated gullet channel, the length sized longer than the elongated gullet channel, and the depth being smaller than the width of the support pad. In another embodiment, the positioning step includes positioning a support pad of the gullet supporting portion along and within the gullet channel such that the support pad extends with a sleeve structure around both sides of a support strap of the gullet supporting portion.

In another embodiment, the method further includes adjusting an effective length of the shoulder strap portion with an adjustable buckle positioned along a shoulder strap of the shoulder strap portion. In another embodiment, the method further includes adjusting an effective length of the gullet supporting portion with an adjustable buckle positioned along a support strap of the gullet supporting portion.

In another embodiment, the coupling step includes coupling the one end of the shoulder strap portion to the first end portion of the gullet supporting portion with clasping structure. In still another embodiment, the coupling step includes coupling one of a first and second end of the shoulder strap portion to one of the first end portion and a second end portion of the gullet supporting portion with clasping structure.

In another embodiment, the supporting step includes positioning a shoulder pad of the shoulder strap portion over the shoulder of the person such that the shoulder pad is coupled to a shoulder strap of the shoulder strap portion. In another embodiment, the supporting step includes manually lifting the shoulder strap portion over the shoulder of the person so that the sling assembly suspends the saddle alongside the person. In still another embodiment, the method further includes removing the sling assembly from the saddle; and compacting the sling assembly to a least one of a folded or rolled position for storing the sling assembly. In another embodiment, the supporting step includes positioning a shoulder pad of the shoulder strap portion over the shoulder of the person such that the shoulder pad exhibits traction nubs on a surface of the shoulder pad to assist maintaining the shoulder strap portion over the shoulder.

In accordance with another embodiment of the present invention, a sling assembly for manually carrying a saddle is provided. The sling assembly includes an elongated shoulder strap portion and an elongated gullet supporting portion. The shoulder strap portion extends between a first end portion and a second end portion such that the shoulder strap portion is adjustable to modify an effective length of the elongated shoulder strap portion. The gullet supporting portion extends between opposite first and second ends such that at least one of the first and second ends sized and configured to be removably coupled to the respective first and the second end portions of the shoulder strap portion. The gullet supporting portion extends with a length and a width sized and configured to be positioned along and within an elongated gullet channel defined in an underside of the saddle in a snug manner to limit longitudinal and lateral movement of the elongated gullet supporting portion relative to the saddle.

In another embodiment, the gullet supporting portion includes a support pad sized and configured to extend along a majority of the length of the gullet supporting portion. In another embodiment, the shoulder strap portion includes a shoulder pad removably coupled to a shoulder strap of the shoulder strap portion. In still another embodiment, the sling assembly further includes a shoulder pad and a support pad, the shoulder pad removably coupled to the shoulder strap portion and the support pad coupled to the gullet supporting portion. In another embodiment, the shoulder pad includes traction nubs along a surface of the shoulder pad, the traction nubs sized and configured to assist in maintaining the shoulder strap over the shoulder of a person.

In another embodiment, the gullet supporting portion is removably coupled to the shoulder strap portion with clasping structure. In another embodiment, the elongated strap portion includes an adjustable buckle coupled thereto, the adjustable buckle sized and configured to modify the effective length of the elongated strap portion. In still another embodiment, the gullet supporting portion includes an adjustable buckle coupled thereto, the adjustable buckle sized and configured to modify the effective length of the gullet supporting portion.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective front view of a sling assembly in a use position, depicting the sling assembly positioned to support a saddle, according to an embodiment of the present invention;

FIG. 1A is a bottom view of the saddle, depicting a gullet channel defined by panels along the underside of the saddle;

FIG. 1B is a bottom view of the saddle, depicting a gullet supporting portion of the sling assembly positioned along the gullet channel of the saddle, according to another embodiment of the present invention;

FIG. 2 is a perspective top view of the sling assembly, depicting the sling assembly in a dis-assembled state, according to another embodiment of the present invention;

FIG. 3 is a perspective top view of the sling assembly, depicting the sling assembly in an assembled state, according to another embodiment of the present invention;

FIG. 4 is a partial perspective side view of the sling assembly, depicting a removable shoulder pad in an unattached state relative to a shoulder strap of the sling assembly, according to another embodiment of the present invention;

FIG. 5 is a partial perspective side view of the sling assembly, depicting the removable shoulder pad in an attached state relative to the shoulder strap of the sling assembly, according to another embodiment of the present invention;

FIG. 6 is partial perspective side view of the sling assembly, depicting the removable shoulder pad in a partially unattached state relative to the shoulder strap of the sling assembly, according to another embodiment of the present invention;

FIG. 7 is a perspective side view of the sling assembly in a use position, depicting the sling assembly positioned to support another type of saddle, according to another embodiment of the present invention;

FIG. 7A is a bottom view of the saddle of FIG. 7, depicting the gullet channel defined by panels along the underside of the dressage saddle;

FIG. 8 is a perspective top view of another embodiment of a sling assembly, according to another embodiment of the present invention;

FIG. 9 is a perspective top view of another embodiment of a shoulder strap portion, according to the present invention; and

FIG. 10 is a perspective bottom view of the shoulder strap of FIG. 9, according to another embodiment of the present invention.

### DETAILED DESCRIPTION OF THE INVENTION

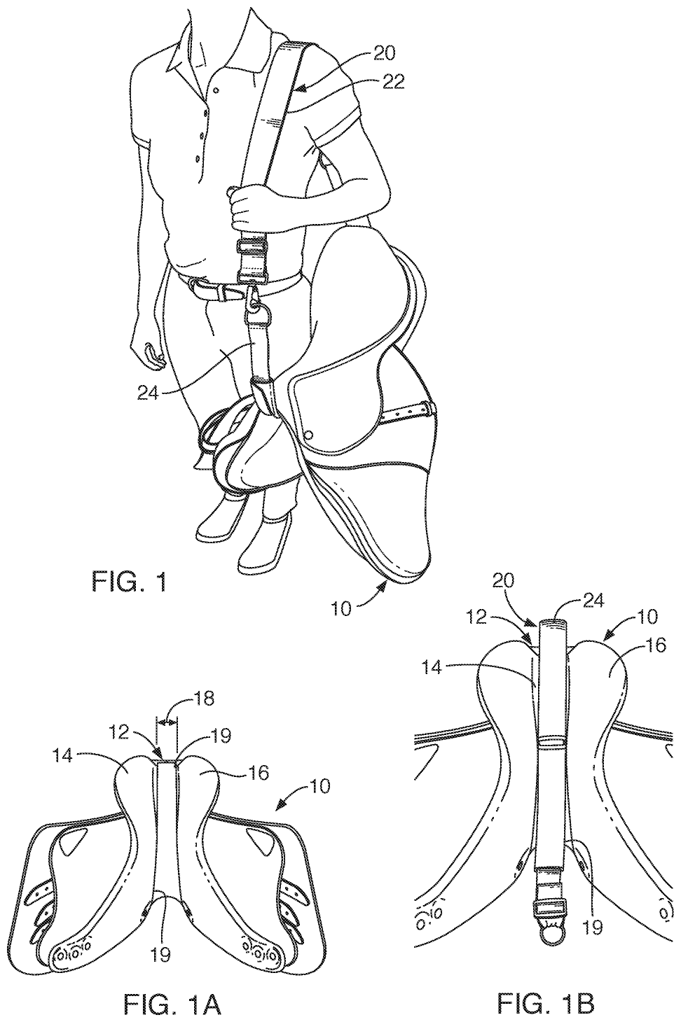

Referring to FIGS. 1, 1A, and 1B, a sling assembly 20 sized and configured to be employed as a tool to assist one carrying a saddle 10, such as the depicted hunter or jumper type saddle, is provided. The sling assembly 20 may be employed with any type of saddle 10. The sling assembly 20 may extend with a shoulder strap portion 22 and a gullet supporting portion 24 such that respective end portions of the shoulder strap portion 22 and gullet supporting portion 24 may be removably coupled together to define a continuous loop. The sling assembly 20 may be readily employed for transporting the saddle 10 with the gullet supporting portion 24 positioned along a gullet channel 12 of the saddle 10 and the shoulder strap portion 22 positioned over one's shoulder. Saddles 10 all include a gullet channel 12 defined by raised panels 14 along an underside 16 of the saddle 10 so that, upon placing the saddle 10 over the back of a horse, the gullet channel 12 is alignably positioned to sit along, and protect, the spine of the horse. It is along the gullet channel 12 defined in the underside 16 of the saddle 10 that the gullet supporting portion 24 may be positioned such that, with the saddle 10 being in an upright position, the saddle 10 may be lifted upward with the shoulder strap portion 22 and positioned over one's shoulder. In this manner, the sling assembly 20 may be employed to assist manually transporting the saddle 10 with the saddle positioned along one's side while also allowing one's hands to be free while carrying the saddle 10 from one location to another.

Further, when the sling assembly 20 is not in use, the sling assembly 20 may readily be moved to a compact state, by folding or rolling the sling assembly 20 into a minimally sized position so that the sling assembly 20 can be stored away in one's hand bag or the like or readily hung loosely over a hook. In this manner, the sling assembly 20 is highly portable. Further, the sling assembly 20 is made of components that can be readily disassembled and placed in the wash for washing individual components or as a whole.

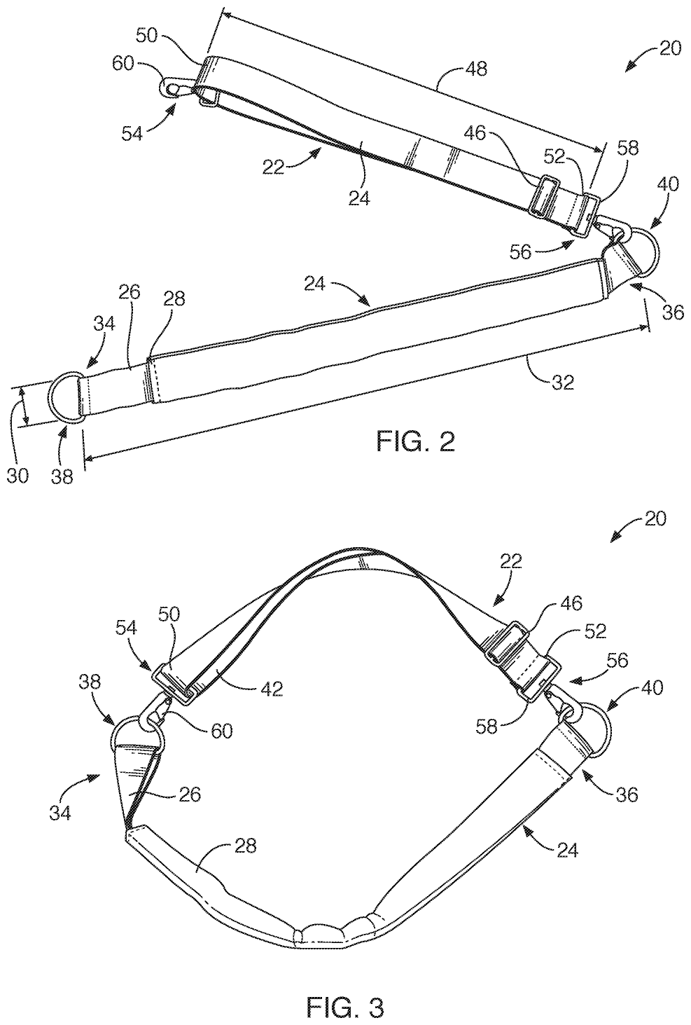

Now with reference to FIGS. 2 and 3, as previously set forth, the sling assembly 20 may include two primary portions: the shoulder strap portion 22 and the gullet supporting portion 24. The gullet supporting portion 24 may be flexible and include an elongated support strap 26 and a support pad 28. The support strap 26 may be formed of a polymeric strap material, such as Nylon strap material. The support strap 26 may extend with a width 30, a length 30, and a depth or thickness, the thickness being about the thickness of a typical strap. The width 30 may be sized and configured to be positioned between the raised panels 14 and along the gullet channel 12 defined in the saddle 10. Further, the width 30 dimension may span and correspond with a width 18 of the gullet channel 12 or may be smaller than the width 18 of the gullet channel 12 defined in the saddle 10, as depicted in FIGS. 1A and 1B. The width 30 dimension of the support strap 26 may be shorter than the length 32 dimension. The length 32 of the support strap 26 may be sized and configured to extend along an entire length of the gullet channel 14 defined in the saddle 10 such that the length 32 of the support strap 26 may extend beyond so as to be longer than the gullet channel 12 of the saddle 10. In this manner, upon the sling assembly 20 being positioned to support the saddle 10, the support strap 26 may extend around ends 19 of the gullet channel 12, as depicted in FIG. 1. In one embodiment, the length 32 of the support strap 26 may be about twenty-four inches, but is not limited to such length as the support strap 26 may also extend shorter or longer. In one embodiment, the width 30 of the support strap 26 may extend about two inches or a width dimension about the width 18 or smaller of typical gullet channel 12 defined in the underside 16 of the saddle 10.

Further, the support strap 26 may extend between a first end portion 34 and a second end portion 36, the first and second end portions 34, 36 being at opposite ends of the support strap 26. The first and second end portions 34, 36 may be folded over and stitched to define and form opposite first and second loops. Each of the first and second loops may be coupled to first and second coupling members 38, 40. Such first and second coupling members 38, 40 may be in the form of a ring, such as a D-ring or O-ring, or similar coupling structure.

The support pad 28 may be elongated and may be sized and configured to be positioned around a portion of the support strap 26 so as to extend to the first and second end portions 34, 36 of the support strap 26. Such support pad 28 may be sized and configured to define a soft structure that minimizes any scrapping or waring of the saddle leather and may fit snug within and along the length of the gullet channel 12 defined in the saddle 10 (see FIG. 1B). In one embodiment, the support pad 28 may be coupled to the support strap 26 in a permanent manner. In another embodiment, the support pad 28 may be removably coupled to the support strap 26 so that, for example, the support pad 28 may be readily removed for washing purposes or the like. The support pad 28 may extend with a sleeve like structure such that the support pad 28 may substantially maintain the support strap 26 from becoming twisted therein. The support pad 28 may be padded on one side and non-padded along an opposite side. The support pad 28 may be elongated so as to extend between first and second opposite ends. The support pad 28 may be a flexible padded structure and may be positioned to wrap around the support strap 26 so that a majority of the length 32 of the support strap 26 is surrounded by the support pad 28. The flexible padded structure of the support pad 28 may be a flat structure that may be removably coupled to the support strap 26 with, for example, snaps, Velcro, or any other suitable structure facilitating ready removal and attachment of the support pad 28 relative to the support strap 26. The support pad 28 may include a fleece exterior or other cloth type. The support pad 28 may define a quilted structure along an exterior surface of the support pad 28. The support pad 28 may also define a batting between opposite exterior surfaces of the support pad 28. With this arrangement, the support strap 26 and the support pad 28 of the gullet supporting portion 24 may be sized and configured to be positioned along the gullet channel 12 of the saddle 10 and act as a support structure that will limit ware and deformation to the saddle 10.

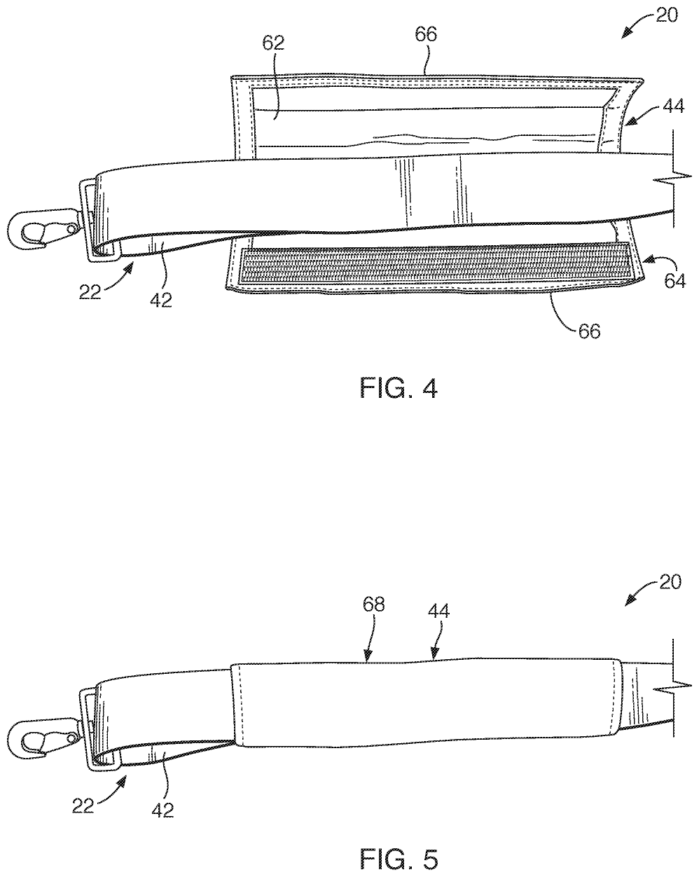

The shoulder strap portion 22 of the sling assembly 20 may include a shoulder strap 42 and a shoulder pad 44 (see FIGS. 4 and 5). The shoulder strap 42 may be an elongated flexible strap structure extending between first and second ends 50, 52 with an adjustable buckle 46 therebetween. The shoulder strap 42 may extend through the adjustable buckle 46 in a manner so as to be configured to facilitate adjustment of the effective length 48 of the shoulder strap 42. In another embodiment, an adjustable buckle may be associated with the gullet supporting portion 24, in addition to (or instead of) the adjustable buckle 46 of the shoulder strap portion 22.

The first and second ends 50, 52 or end portions of the shoulder strap 42 may be looped and/or stitched to include respective first and second coupling structures 54, 56. Each of the first and second coupling structures 54, 56 may include a ring structure 58 associated with a clasping structure 60. In another embodiment, one of the first and second coupling structures 54, 56 may include the ring and clasping structure 58, 60. The clasping structures 60 may be in the form of, for example, a swivel lobster clasp or any clasping structure or the like. Such first and second coupling structures 54, 56 of the shoulder strap portion 22 may couple to first and second coupling members 38, 40 of the gullet supporting portion 24. In this manner, the shoulder strap portion 22 may be assembled with the gullet supporting portion 24 to form the continuous loop. Such coupling and decoupling of the first and second coupling structures 54, 56 may be readily implemented to quickly couple the sling assembly 20 around the underside 16 of the saddle 10, or to decouple the sling assembly 20 from the saddle 10.

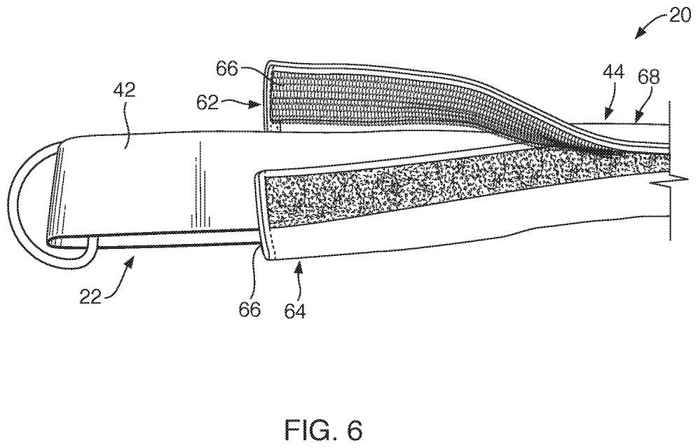

Now with reference to FIGS. 4-6, as previously set forth, the shoulder strap portion 22 of the sling assembly 20 may also include a shoulder pad 44. The shoulder pad 44 may be sized and configured to be positioned around the shoulder strap 42 to provide a larger padded surface area than that of the shoulder strap 42 to, thereby, minimize the force placed on one's shoulder (or spread the force out over the larger surface area). The shoulder pad 44 may include a batting or foam material positioned between inner and outer surfaces of the shoulder pad 44. The shoulder pad 44 may be a flexible flat structure 62 when opened up in a decoupled or detached state, as depicted in FIG. 4. In the decoupled state, the flexible flat structure 62 may be positioned along one side of the shoulder strap 42 and folded over the shoulder strap 42 to couple the shoulder pad 44 to the shoulder strap 42. In the coupled state of the shoulder pad 44, the shoulder pad 44 extends with a sleeve structure 68, as depicted in FIG. 5. The shoulder pad 44 may include integrated coupling structure 64 along, for example, end portions 66 of the shoulder pad 44. For example, the integrated coupling structure 64 of the shoulder pad 44 may be in the form of snap structure or Velcro or any other suitable integrated coupling structure 64 that facilitates ready removal of the shoulder pad 44 from the shoulder strap 42. In this manner, the shoulder pad 44 may be manually moved to the coupled state to exhibit the sleeve structure 68 and may be manually moved to the decoupled state so that the shoulder pad 44 exhibits the flexible flat structure 62.

In another embodiment, the shoulder pad 44 may be permanently attached or fixated to the shoulder strap 42. In another embodiment, the shoulder pad 44 may be attached to the shoulder strap 42 such that padding is only on a single side of the shoulder strap 42. In another embodiment, the shoulder pad 44 may be integrally integrated with the shoulder strap 42. In another embodiment, the shoulder pad 44 may be slidingly moveable along a length of the shoulder strap 42.

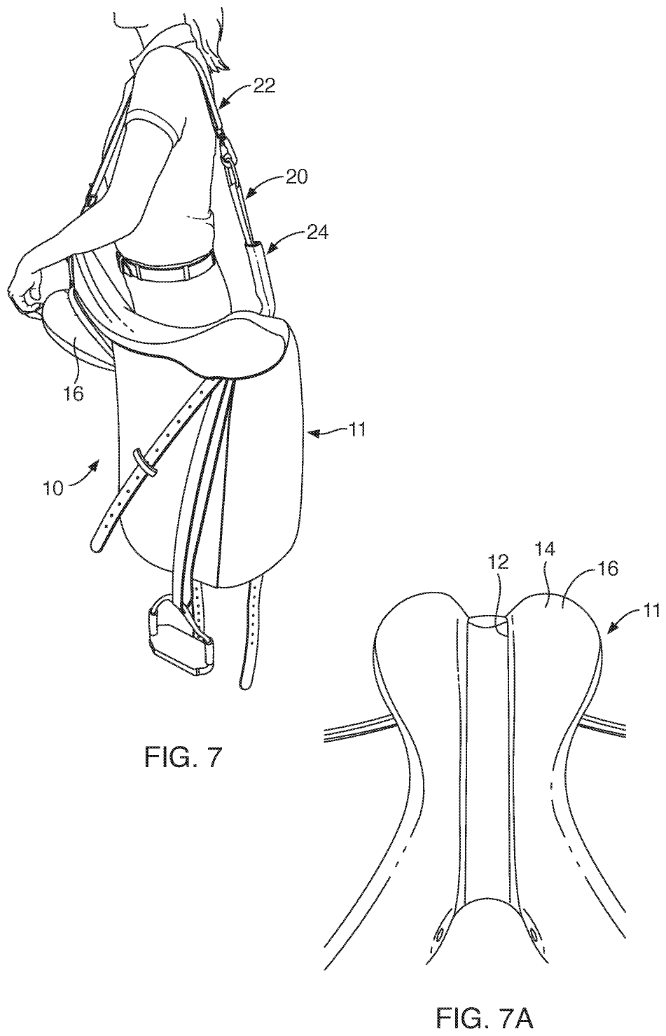

The sling assembly 20, as set forth above, may be employed with any type of saddle 10. For example, as depicted in FIGS. 7 and 7A, the sling assembly 20 may be employed with other types of saddles, such as a dressage saddle 11 or the like. As previously set forth, each saddle version, such as the dressage saddle 11, will include the gullet channel 12 defined by raised panels 14 along an underside 16 of the saddle 11 to protect the spine of the horse. As such, similar to that previously described and depicted in FIGS. 1 and 1A with the hunter saddle, the gullet supporting portion 24 may be similarly positioned along the gullet channel 12 of the dressage saddle 11 so that a user may readily lift the dressage saddle 11 with the shoulder strap portion 22 and then position the shoulder strap portion 22 over one's shoulder to suspend the saddle 11 along one's side. In this manner, the sling assembly 20 may be employed to assist one to readily carry any type of saddle 10 while also freeing one's hands through the process of moving the saddle from one location to another.

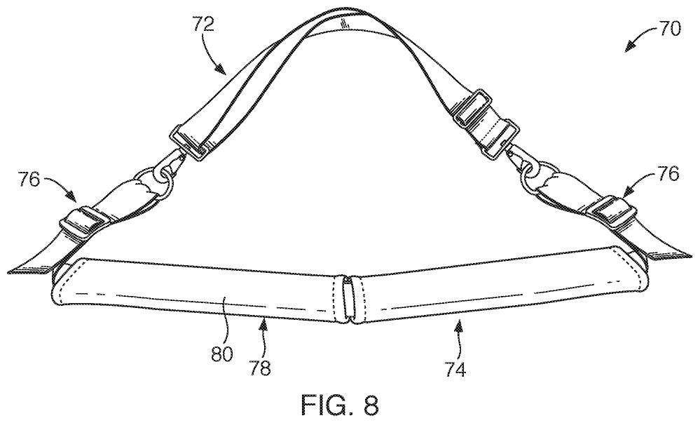

Now with reference to FIG. 8, another embodiment of a sling assembly 70 for supporting a saddle (not shown) for manual transport is provided. The sling assembly 70 may include a shoulder strap portion 72 and a gullet supporting portion 74, similar to that described and depicted in the previous embodiment. In this embodiment, the gullet supporting portion 74 may include one or more adjustment buckles 76, to adjust the effective length of the gullet supporting portion 74. Also, the gullet supporting portion 74 may include a pad 78 that extends with a quilted pattern along an exterior surface 80 of the pad 78. Similar to the previous embodiment, the shoulder strap portion 72 may include a pad attached thereto, that may be permanently attached or removably attached to the shoulder strap portion.

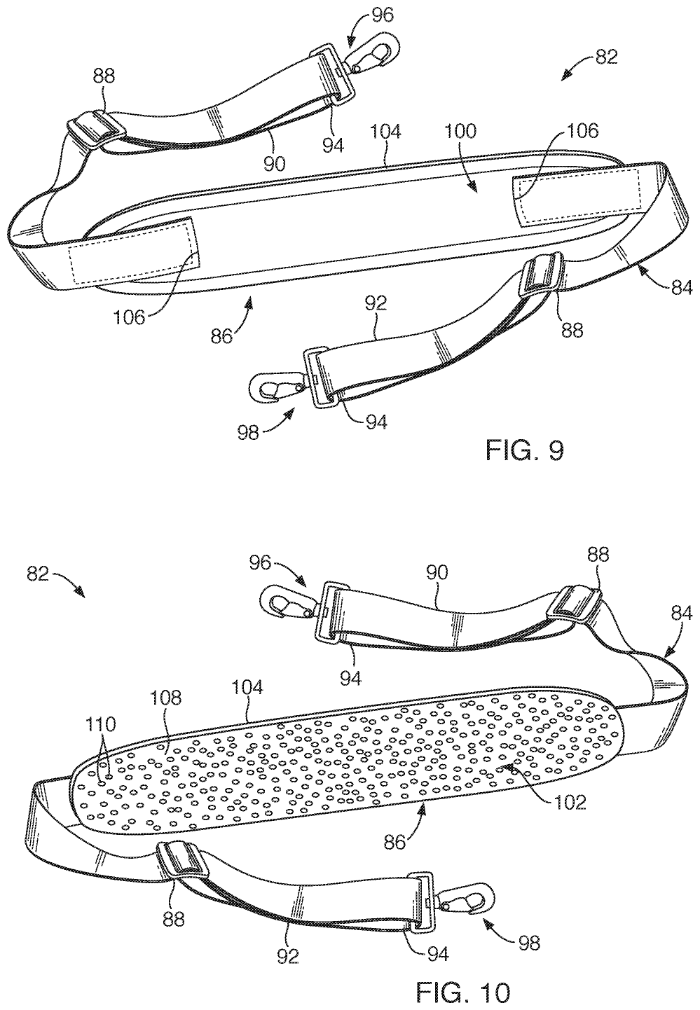

With reference to FIGS. 9 and 10, another embodiment of a shoulder strap portion 82 is provided. This embodiment of the shoulder strap portion 82 may be employed with any of the gullet supporting portions 24, 74 (see respective FIGS. 3 and 8) set forth herein. The shoulder strap portion 82 may include similar structure and provide similar function to the shoulder strap portions of previous embodiments. For example, the shoulder strap portion 82 may include a shoulder strap 84 and a pad portion 86. The shoulder strap 84 may include one or more buckles 88 sized and configured to adjust an effective length of the shoulder strap 84, similar to previous embodiments. Further, the shoulder strap 84 may include first and second end portions 90, 92 that may exhibit loop ends 94. The loop ends 94 may be sized and configured to couple to first and second coupling structures 96, 98, similar to previous embodiments. In this embodiment, the pad portion 86 may be slidingly coupled to the shoulder strap 84. The pad portion 86 may extend with an elongated structure and may extend to define an outer side 100 and an underside 102 each extending to define a periphery 104 of the pad portion 86. The outer side 100 may define one or more slits 106 or slots or the like that may be sized and configured to receive or thread the shoulder strap 84 therethrough. The underside 102 of the pad portion 86 may extend with a surface 108 with traction nubs 110 or bumps formed thereon. The surface 108 of the underside 102 and the traction nubs 110 of the pad portion 86 may be formed from a polymeric material, such as a rubber material or the like. Such traction nubs 110 may be the surface that sits against one's shoulder so that the traction nubs 110 of the pad portion 86 may facilitate a gripping characteristic against the shoulder. Further, as in previous embodiments, the pad portion 86 may be padded and extend with a larger surface area than a side of the shoulder strap 84 so as to provide structure to limit discomfort over one's shoulder. With this arrangement, the shoulder strap portion 82 of this embodiment may be employed with a gullet supporting portion of any one of the embodiments set forth herein to form a sling assembly.

With reference to FIG. 2, the various structural components of the sling assembly 20 (as well as the other embodiments of the sling assembly herein) including the shoulder strap portion 22 and the gullet supporting portion 24 may be formed of flexible materials that can readily be rolled up or folded into a compact position for storage or ready transport in one's hand bag or the like. Further, various components of the sling assembly 20, such as the support pad 28 and the shoulder pad 44, may readily be removed from the sling assembly 20 for washing, or in the alternative, the entire sling assembly 20 may be washed as desired. Further, the sling assembly 20 may be formed of various polymeric materials. For example, the support strap 26 and the shoulder strap 42 of the sling assembly 20 may be formed of various woven polymeric materials, such as Nylon, or any other suitable strap material such as woven natural fibers, and manufactured using known processes and techniques as known to one of ordinary skill in the art. Further, the first and second coupling members 38, 40 and first and second coupling structures 54, 56 of the sling assembly 20 may be formed of metallic materials and/or a high strength rigid polymeric material and formed using known manufacturing techniques as known by one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A method for a person to manually carry a saddle, the method comprising:
positioning an elongated gullet supporting portion of a sling assembly along and within an elongated gullet channel defined in an underside of the saddle;
coupling one end of an elongated shoulder strap portion to a first end portion of the elongated gullet supporting portion so that the elongated shoulder strap portion and the elongated gullet supporting portion are coupled together in a continuous loop; and
supporting the saddle with the sling assembly by positioning the elongated shoulder strap portion over a shoulder of the person with the elongated gullet supporting portion held and positioned along the gullet channel of the saddle.

2. The method according to claim 1, wherein the positioning comprises positioning the gullet supporting portion along the gullet channel such that the gullet supporting portion is sized to limit longitudinal and lateral movement of the elongated gullet supporting portion relative to raised panels defining the gullet channel in the underside of the saddle.

3. The method according to claim 1, wherein the positioning comprises positioning a support pad of the gullet supporting portion along and within the gullet channel of the saddle such that the support pad at least partially surrounds a support strap of the gullet supporting portion.

4. The method according to claim 1, wherein the positioning comprises positioning a support pad of the gullet supporting portion along and within the gullet channel of the saddle such that the support pad extends beyond ends of the gullet channel.

5. The method according to claim 1, wherein the positioning comprises positioning a support pad of the gullet supporting portion along and within the gullet channel such that the support pad defines a width, a length, and a depth, the width sized to be about a width of the elongated gullet channel, the length sized longer than the elongated gullet channel, and the depth being smaller than the width of the support pad.

6. The method according to claim 1, wherein the positioning comprises positioning a support pad of the gullet supporting portion along and within the gullet channel such that the support pad extends with a sleeve structure around both sides of a support strap of the gullet supporting portion.

7. The method according to claim 1, further comprising adjusting an effective length of the shoulder strap portion with an adjustable buckle positioned along a shoulder strap of the shoulder strap portion.

8. The method according to claim 1, further comprising adjusting an effective length of the gullet supporting portion with an adjustable buckle positioned along a support strap of the gullet supporting portion.

9. The method according to claim 1, wherein the coupling comprises coupling the one end of the shoulder strap portion to the first end portion of the gullet supporting portion with clasping structure.

10. The method according to claim 1, wherein the coupling comprises coupling one of a first and second end of the shoulder strap portion to one of the first end portion and a second end portion of the gullet supporting portion with clasping structure.

11. The method according to claim 1, wherein the supporting comprises positioning a shoulder pad of the shoulder strap portion over the shoulder of the person such that the shoulder pad exhibits traction nubs on a surface of the shoulder pad to assist maintaining the shoulder strap portion over the shoulder.

12. The method according to claim 1, wherein the supporting comprises manually lifting the shoulder strap portion over the shoulder of the person so that the sling assembly suspends the saddle alongside the person.

13. The method according to claim 1, further comprising removing the sling assembly from the saddle; and compacting the sling assembly to a least one of a folded or rolled position for storing the sling assembly.

14. A sling assembly for manually carrying a saddle, comprising:
an elongated shoulder strap portion extending between a first end portion and a second end portion, the shoulder strap portion being adjustable to modify an effective length of the elongated shoulder strap portion; and
an elongated gullet supporting portion extending between opposite first and second ends, at least one of the first and second ends sized and configured to be removably coupled to the respective first and the second end portions of the elongated shoulder strap portion, the elongated gullet supporting portion extending with a length and a width sized and configured to be positioned along and within a gullet channel defined in an underside of the saddle in a snug manner to limit longitudinal and lateral movement of the elongated gullet supporting portion relative to the gullet channel of the saddle.

15. The sling assembly of claim 14, wherein the gullet supporting portion comprises a support pad sized and configured to extend along a majority of the length of the gullet supporting portion.

16. The sling assembly of claim 14, wherein the shoulder strap portion comprises a shoulder pad removably coupled to a shoulder strap of the shoulder strap portion.

17. The sling assembly of claim 14, further comprising a shoulder pad and a support pad, the shoulder pad removably coupled to the shoulder strap portion and the support pad coupled to the gullet supporting portion.

18. The sling assembly of claim 14, wherein the gullet supporting portion is removably coupled to the shoulder strap portion with clasping structure.

19. The sling assembly of claim 14, wherein the elongated strap portion comprises an adjustable buckle coupled thereto, the adjustable buckle sized and configured to modify the effective length of the elongated strap portion.

20. The sling assembly of claim 14, wherein the gullet supporting portion comprises an adjustable buckle coupled thereto, the adjustable buckle sized and configured to modify the effective length of the gullet supporting portion.
